(19) United States
(12) Patent Application Publication
(10) Pub. No.: US 2008/0087794 A1
(43) Pub. Date: Apr. 17, 2008

(54) Mold Assembly

(75) Inventors: HF L, Dongguan (CN); QH Yuan, Dongguan City (CN)

Correspondence Address: GROSSMAN, TUCKER, PERREAULT & PFLEGER, PLLC, 55 SOUTH COMMERICAL STREET, MANCHESTER, NH, 03101, US

(73) Assignees: DELTA ELECTRONICS COMPONENTS (DONGGUAN) CO., LTD., Dong-Guan City (CN); DELTA ELECTRONICS, INC., Taoyuan Hsien (TW)

(21) Appl. No.: 11/848,287

(22) Filed: Aug. 31, 2007

(30) Foreign Application Priority Data
Oct. 12, 2006 (TW) 095137569

(51) Int. Cl. B29C 33/02

(52) U.S. Cl. 249/187.1

(57) ABSTRACT

A mold assembly for forming a plurality of components, which can be assembled into a final product, is provided. In accordance with the components, the mold assembly includes a plurality of male molds and female molds for correspondingly forming a plurality of cavities. The components can be simultaneously molded in a single molding process and then assembled, thereby, enhancing the stability of the final product, eliminating the need to keep a large stock of the products, and reducing manufacturing costs.

This application claims priority to Taiwan Patent Application No. 095137569 filed on Oct. 12, 2006; the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a processing apparatus; in particular, it relates to a mold assembly, which can simultaneously produce elements that correspond to each other.

2. Descriptions of the Related Art

Injection-molding technology is a well-known manufacturing process. Generally, a mold comprises main elements such as a mold base, a fixed male mold plate, a male mold, a fixed female mold plate, and a female mold. The mold base or the fixed plates can be formed with a runner and a cooling channel that facilitates to introduce plastic materials while performing the injection-molding process.

Similar to the cooling fan used in a computer, the elements of the cooling fan usually comprise a frame, blades, an upper cover and a lower cover. The conventional method for producing these elements is to design a set of molds for each element, independently. Even though the upper cover and the lower cover can be molded using just one set of molds, at least three sets of molds are needed for producing the cooling fan. As a result, producing a relatively simple structure, such as a fan, still requires the use of more than three or four molds for manufacturing these elements. Then, the elements still need to be assembled after manufactured.

Furthermore, there are other disadvantages in using the above-mentioned method. For example, after these elements are manufactured, every element is first stocked in a warehouse, and then set on the production line during assembly. In this way, stocks of the elements become an issue during the manufacturing processes. Moreover, because the elements are manufactured by different molds, a mold of poor quality will affect assembly of the final products. In addition, elements made by other molds may be stored away due to failing in assembly. This results in consuming manpower and increasing material resources cost. The stability of the final product may be poor if these elements are made of different quality. Furthermore, various molds for producing various elements will obviously increase the manufacturing cost due to the high cost of a mold.

Therefore, a mold assembly, which can produce elements simultaneously, needs to be developed in this yield.

### SUMMARY OF THE INVENTION

The primary objective of the present invention is to provide a mold assembly for simultaneously manufacturing various elements of a plastic object using only a single set of molds. The stability of the assembly object can be increased when these elements are formed using only a single set of molds. Moreover, on the production line, the number of molds, as well as the frequency of changing the molds, is greatly reduced. Thus, the stocks of the elements will fall due to the stability of the assembly, and the cost of manufacturing will be reduced as well.

Another objective of the present invention is to provide a mold assembly for using one set of molds on the single production line for injection-molding and subsequent product assembling. Thus, the present invention can reduce the amount of element transportation, and the manufacturing processes can be more easily and efficiently managed.

For the aforementioned objectives, the mold assembly disclosed by the present invention is used for forming an object, which comprises a first element, a second element and a third element. The mold assembly comprises a runner, a fixed male mold plate, a male mold core, a fixed female mold plate, and a female mold. The male mold core is disposed onto the fixed male mold plate and comprises a first male mold portion, a second male mold portion and a third male mold portion. These male mold portions are separately connected to the runner. The female mold is disposed onto the fixed female mold plate and comprises a first female mold portion, a second female mold portion and a third female mold portion. The first male mold portion and the first female mold portion corresponding thereto form a first mold cavity complementary in shape to the first element. Likewise, the second male mold portion and the second female mold portion corresponding thereto form a second mold cavity complementary in shape to the second element, and the third male mold portion and the third female mold portion corresponding thereto form a third element complementary in shape to the third element.

According to the mold assembly disclosed by the present invention, the elements of the object are manufactured by using a single mold. After the injection-molding process, the elements are simultaneously molded and then assembled into the object. Thus, it is no longer necessary for each element to be formed using separate molds.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating the female mold structure of the mold assembly of the present invention; and

FIG. 2 is a schematic view illustrating the male mold structure of the mold assembly of the present invention, which corresponds to the female mold structure of FIG. 1.

### DESCRIPTION OF THE PREFERRED EMBODIMENT

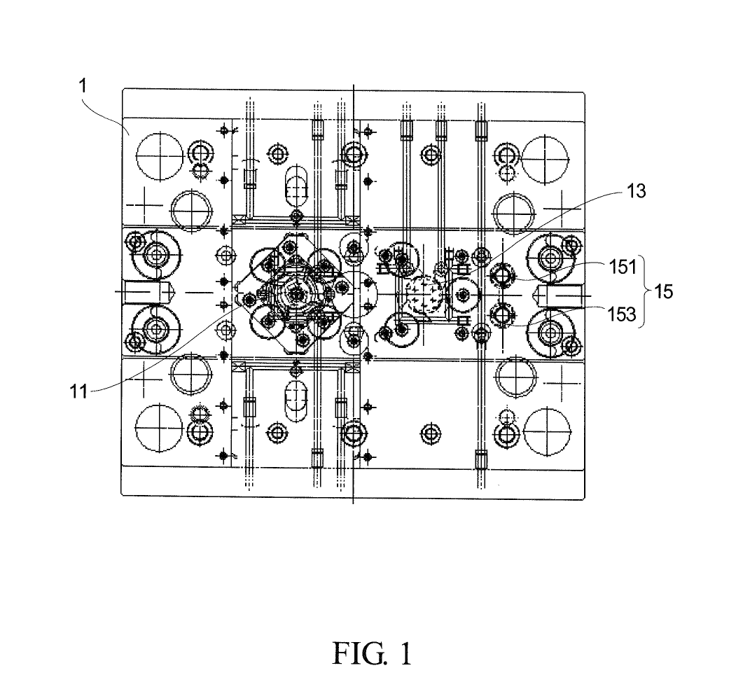

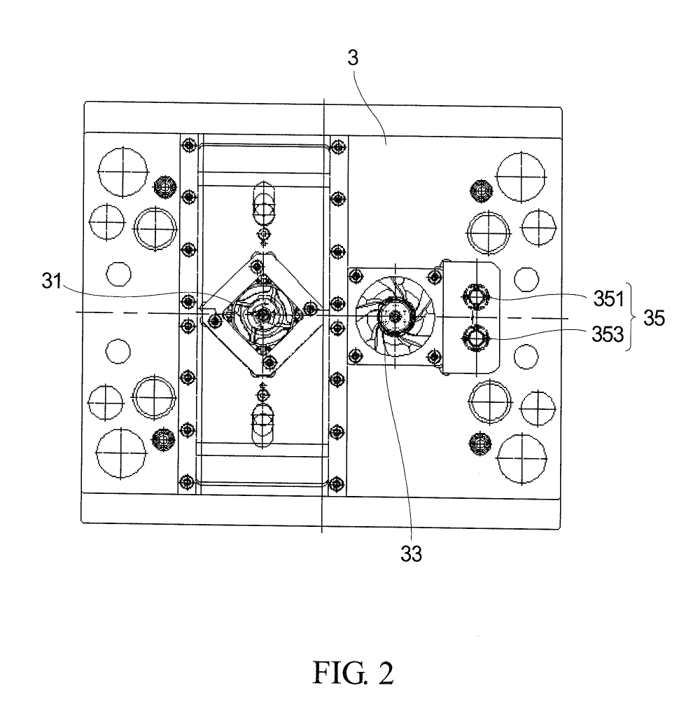

As shown in FIG. 1 and FIG. 2, the mold assembly of the present invention is illustrated. FIG. 1 shows a schematic view of a female mold, and FIG. 2 shows a schematic view of a male mold. Other components of these molds in these figures are similar to the components of the conventional molds. The connections between the molds are also conventional. These components and connections are well known by people skilled in this field and are not superfluously elaborated herein.

The mold assembly of the present invention is used for forming an object, wherein the object comprises a first element, a second element, and a third element. A cooling fan is used as an example for illustration in the following descriptions. The cooling fan comprises a frame, blades disposed therein, and a cover. Specifically, the first element is the frame, the second element includes the blades, and the third element is the cover, wherein the cover further comprises an upper cover and a lower cover corresponding thereto. The cooling fan is formed by assembling the frame, the blades, the upper cover, and the lower cover.

The mold assembly of the present invention comprises a fixed female mold plate 1 and a fixed male mold plate 3. A female mold is disposed onto the fixed female mold plate 1. The female mold comprises a first female mold portion 11, a second female mold portion 13, and a third female mold portion 15. The male mold core is disposed onto the fixed male mold plate 3. The male mold core comprises a first male mold portion 31, a second male mold portion 33, and a third male mold portion 35. More specifically, the first male mold portion 31 and the first female mold portion 11 corresponding thereto form a first mold cavity complementary in shape to the first element. Similarly, the second male mold portion 33 and the second female mold portion 13 corresponding thereto form a second mold cavity complementary in shape to the second element; the third male mold portion 35 and the third female mold portion 15 corresponding thereto form a third mold cavity complementary in shape to the third element. Next, these elements can be formed by injection.

For the upper cover and lower cover, the third female mold portion 15 further comprises an upper cover female mold portion 151 and a lower cover female mold portion 153. The third male mold portion 35 also further comprises an upper cover male mold portion 351 and a lower cover male mold portion 353, wherein the upper cover male mold portion 351 and the upper cover female mold portion 151 corresponding thereto form an upper cover mold cavity complementary in shape to the upper cover. Lastly, the lower cover male mold portion 353 and the lower cover female mold portion 153 corresponding thereto form a lower cover mold cavity complementary in shape to the lower cover.

The mold assembly of the present invention further comprises a symmetric plane. The first female mold portion 11, the second female mold portion 13, the upper cover female mold portion 151 and the lower cover female mold portion 153 are disposed equidistantly about the symmetry plane. In this way, the mold assembly can be uniformly filled with plastic materials in the molding process and thus the forces applied within the mold assembly may be in equilibrium.

Moreover, the mold assembly of the present invention further comprises a runner (not shown), which connects to the first male mold portion 31, the second male mold portion 33, and the third male mold portion 35. The runner is a pouring channel for pouring liquid plastic material into the mold in the molding process. The mold assembly of the present invention can further comprise a cooling channel (not shown), which is disposed onto either the fixed male mold plate 3 or the fixed female mold plate 1. The cooling channel is used to quickly cool the formed elements.

According to the aforementioned mold assembly, the four elements of the cooling fan can be designed by manufactured in the same mold with the injection molding machines. After pouring the plastic material, the mold assembly of the present invention can simultaneously produce those elements. Then, those elements can be assembled into a cooling fan. This manufacturing process can replace the conventional manufacturing process, which required more molds and multiple molding processes. In particularly, the molding process of the present invention only applies with one set of molds in a production line to produce an object. As a result, the present invention has the following advantages: easier production management, efficient production, enhanced stability of the final product, a reduced number of molds, reduced frequency of mold changing, no need for large stocks, and reduced manufacturing costs.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mold assembly for manufacturing an object, which has a first element, a second element and a third element, the mold assembly comprising:
a runner;
a fixed male mold plate;
a male mold core, disposed onto the fixed male mold plate, the male mold core comprising a first male mold portion, a second male mold portion and a third male mold portion each connecting with the runner;
a fixed female mold plate; and
a female mold, disposed onto the fixed female mold plate, the female mold comprising a first female mold portion, a second female mold portion and a third female mold portion;
wherein the first male mold portion and the first female mold portion corresponding thereto form a first mold cavity, substantially complementary in shape to the first element, the second male mold portion and the second female mold portion corresponding thereto form a second mold cavity, substantially complementary in shape to the second element, and the third male mold portion and the third female mold portion corresponding thereto form a third mold cavity, substantially complementary in shape to the third element.

2. The mold assembly as claimed in claim 1, wherein the object is a cooling fan, which comprises a frame, blades disposed therein, and a cover, in which the first element is the frame, the second element includes the blades, and the third element is the cover.

3. The mold assembly as claimed in claim 2, wherein the cover comprising an upper cover and a lower cover opposite to the upper cover.

4. The mold assembly as claimed in claim 3, wherein the third male mold portion comprises an upper cover male mold portion and a lower cover male mold portion, and the third female mold portion comprises an upper cover female mold portion and a lower cover female mold portion, wherein the upper cover male mold portion and the upper cover female mold portion corresponding thereto form an upper cover mold cavity, substantially complementary in shape to the upper cover, and the lower cover male mold portion and the lower cover female mold portion corresponding thereto form a lower cover mold cavity, substantially complementary in shape to the lower cover.

5. The mold assembly as claimed in claim 4, further comprising a symmetric plane, in which the first female mold portion, the second female mold portion, the upper cover female mold portion, and the lower cover female mold portion are symmetrically disposed about the plane.

6. The mold assembly as claimed in claim 1, wherein at least one of the fixed male mold plate and the fixed female mold plate is formed with a cooling channel.
